(19) United States
(12) Patent Application Publication
(10) Pub. No.: US 2025/0138043 A1
(43) Pub. Date: May 1, 2025

(54) Sensor Module and Electronic Apparatus

(71) Applicant: SEIKO EPSON CORPORATION, Tokyo (JP)

(72) Inventor: Taketo CHINO, Hokuto (JP)

(21) Appl. No.: 18/931,495

(22) Filed: Oct. 30, 2024

(30) Foreign Application Priority Data
Oct. 31, 2023 (JP) 2023-186311
Nov. 14, 2023 (JP) 2023-193500

(51) Int. Cl. G01P 1/02; G01C 19/00

(52) U.S. Cl. CPC G01P 1/026; G01C 19/005

(57) ABSTRACT

A sensor module includes a first substrate, a second substrate, a connection portion, a first sensor device, and a second sensor device. The connection portion forms an electrical connection between the first substrate and the second substrate. The first sensor device is disposed on the first substrate to detect a physical quantity on a first axis. The second sensor device is disposed on the second substrate to detect a physical quantity on the first axis.

The present application is based on, and claims priority from JP Application Serial Number 2023-186311, filed Oct. 31, 2023 and JP Application Serial Number 2023-193500, filed Nov. 14, 2023, the disclosures of which are hereby incorporated by reference herein in their entirety.

### BACKGROUND

### 1. Technical Field

The present disclosure relates to a sensor module and an electronic apparatus.

### 2. Related Art

A sensor module disclosed in JP-A-2019-163955, which is an example of related art, includes two X-axis angular rate sensor devices mounted on a side surface of the same substrate to provide high-accuracy X-axis angular rate data.

Such a sensor module including more than one sensor device for one detection axis is expected to undergo further improvements in the effectiveness and reliability of the enhanced accuracy.

### SUMMARY

A sensor module according to an aspect of the present disclosure includes a first substrate, a second substrate, a connection portion, a first sensor device, and a second sensor device. The connection portion forms an electrical connection between the first substrate and the second substrate. The first sensor device is disposed on the first substrate to detect a physical quantity on a first axis. The second sensor device is disposed on the second substrate to detect a physical quantity on the first axis.

A sensor module according to an aspect of the present disclosure includes a first substrate, a second substrate, a third substrate, a first connection portion, a second connection portion, a first sensor device, and a second sensor device. The second substrate is disposed close to one side of the first substrate. The third substrate is disposed close to the one side of the first substrate. The first connection portion forms an electrical connection between the first substrate and the second substrate. The second connection portion forms an electrical connection between the first substrate and the third substrate. The first sensor device is disposed on the second substrate to detect a physical quantity on a first axis. The second sensor device is disposed on the third substrate to detect a physical quantity on the first axis.

An electronic apparatus according to an aspect of the present disclosure includes the sensor module described above.

### BRIEF DESCRIPTION OF THE DRAWINGS

FIG. 1 is a perspective view of a sensor module according to Embodiment 1, illustrating a state in which the sensor module is fastened to a mounting surface.

FIG. 2 is a perspective view of the sensor module in FIG. 1 as seen from the side where the mounting surface is located.

FIG. 3 is an exploded perspective view of the sensor module.

FIG. 4 is a development view of a substrate unit.

FIG. 5 is a development view of the substrate unit.

FIG. 6 is a perspective view of a fixation frame.

FIG. 7A is a sectional view taken along line VIIA-VIIA in FIG. 4.

FIG. 7B is a sectional view taken along line VIIB-VIIB in FIG. 4.

FIG. 8 is a configuration diagram of a sensor device.

FIG. 9 is a development view of a substrate unit in Embodiment 2.

FIG. 10 is a development view of a substrate unit in Embodiment 2.

FIG. 11 is a perspective view of a fixation frame in Embodiment 2.

FIG. 12 is a perspective view of an example of an electronic apparatus according to Embodiment 3.

FIG. 13 is a perspective view of another example of the electronic apparatus according to Embodiment 3.

### DESCRIPTION OF EMBODIMENTS

For greater visibility, constituent elements in each drawing are not necessarily drawn to scale. The X-, Y-, and Z-axes in each drawing are orthogonal to each other. The terms “X-axis direction”, “Y-axis direction”, and “Z-axis direction” herein refer to the direction parallel to the X-axis, the direction parallel to the Y-axis, and the direction parallel to the Z-axis, respectively. The term “plus side” herein refers to each of the sides where the tips of the arrows denoting the X-, Y-, and Z-axes are located, and the term “minus side” herein refers to each of the sides where the proximal ends of the respective arrows are located. The expression “viewed in plan” herein means that a plane including the X-axis and the Y-axis is viewed in the Z-axis direction, and the expression “viewed in cross section” herein means that a cross section including the Z-axis is viewed in the X-axis direction or the Y-axis direction.

The term “upper surface” used in relation to any constituent component in the description below refers to the surface on the plus side in the Z-axis direction of the constituent component concerned. For example, an upper surface of a substrate refers to the surface on the plus side in the Z-axis direction of the substrate. The term “lower surface” used in relation to any constituent component in the description below refers to the surface on the minus side in the Z-axis direction of the constituent component concerned. The term “left side surface” used in relation to any constituent component in the description below refers to the surface on the minus side in the X-axis direction of the constituent component concerned. The term “right side surface” used in relation to any constituent component in the description below refers to the surface on the plus side in the X-axis direction of the constituent component concerned.

### 1. Embodiment 1

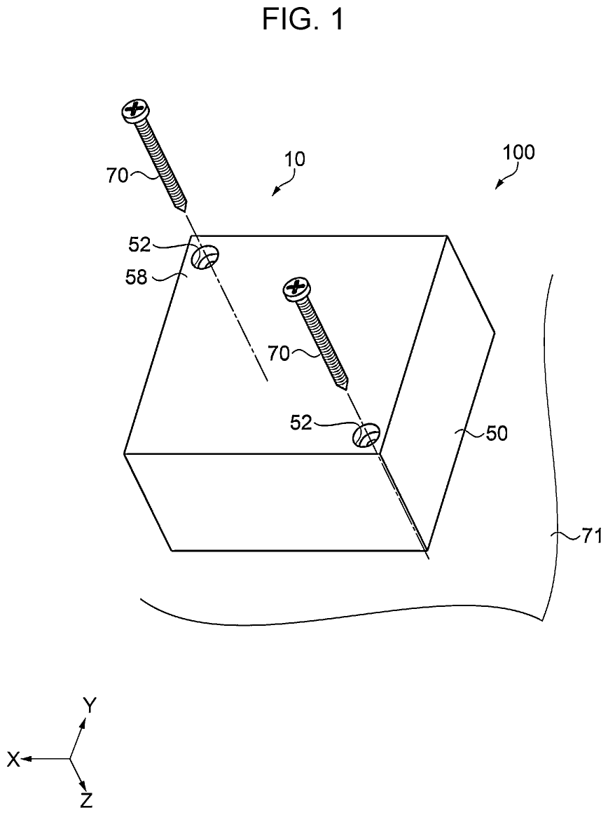

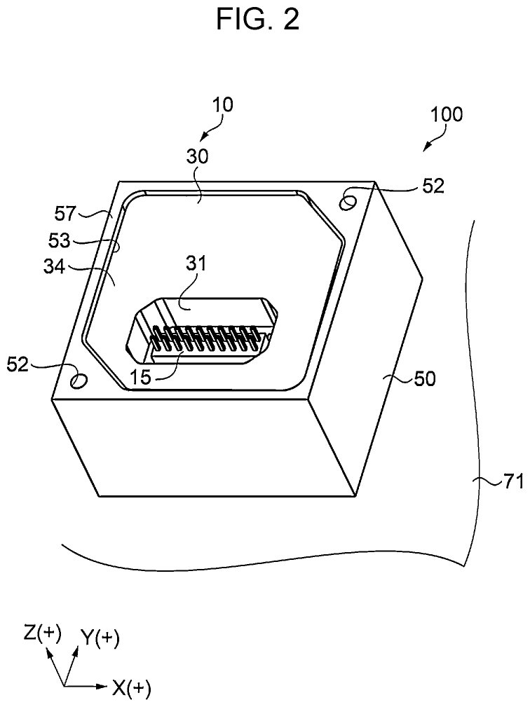

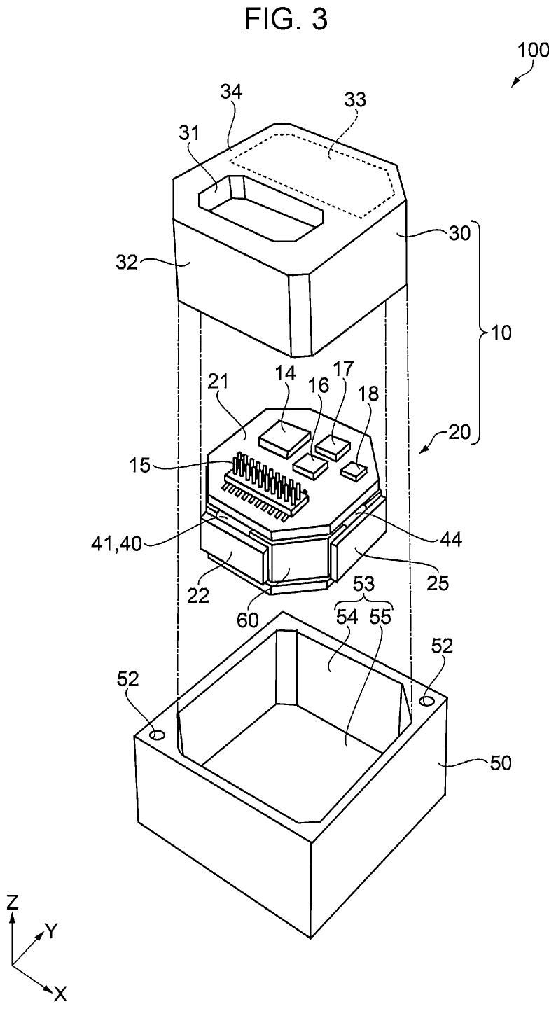

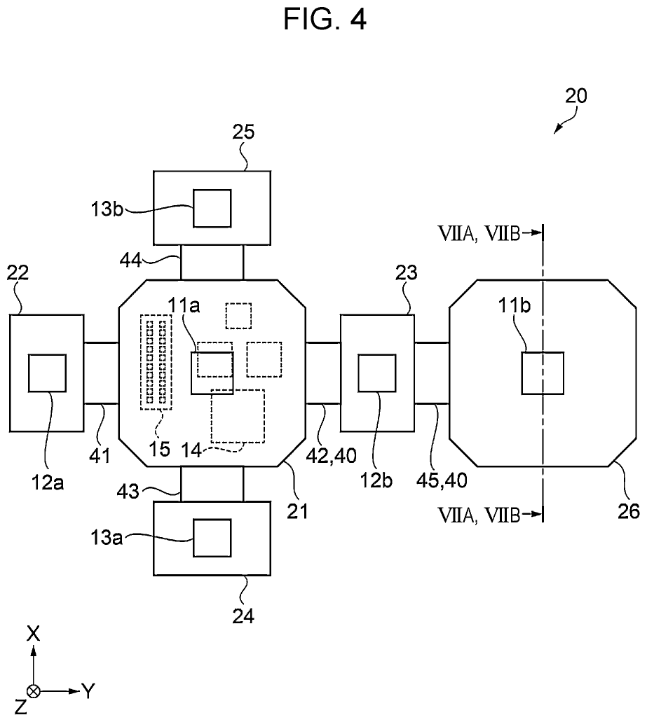

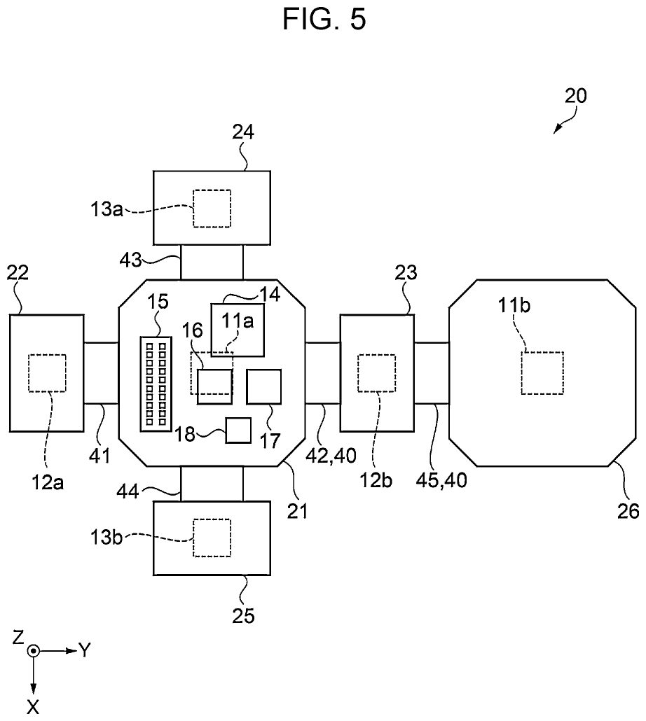

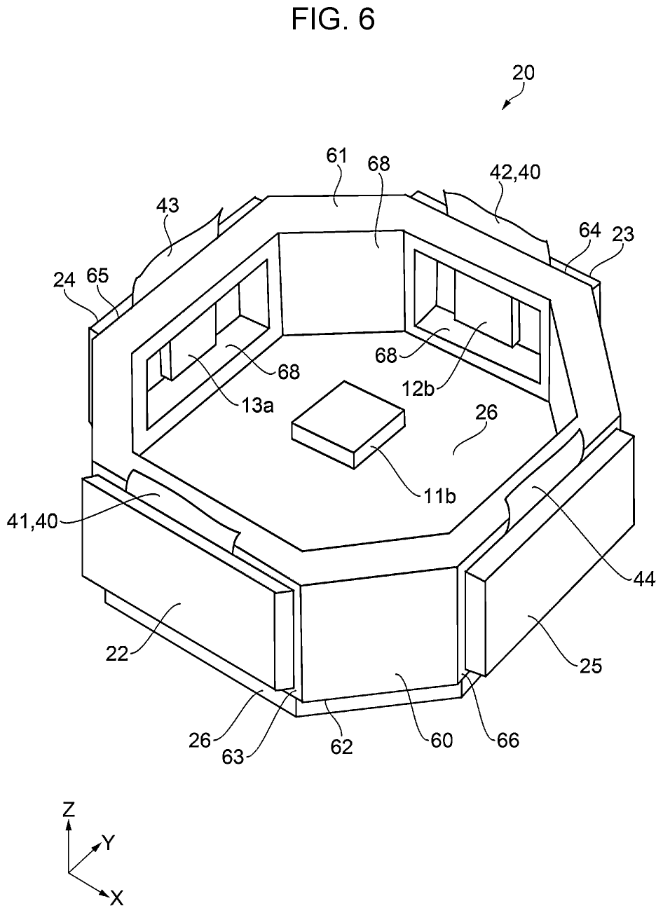

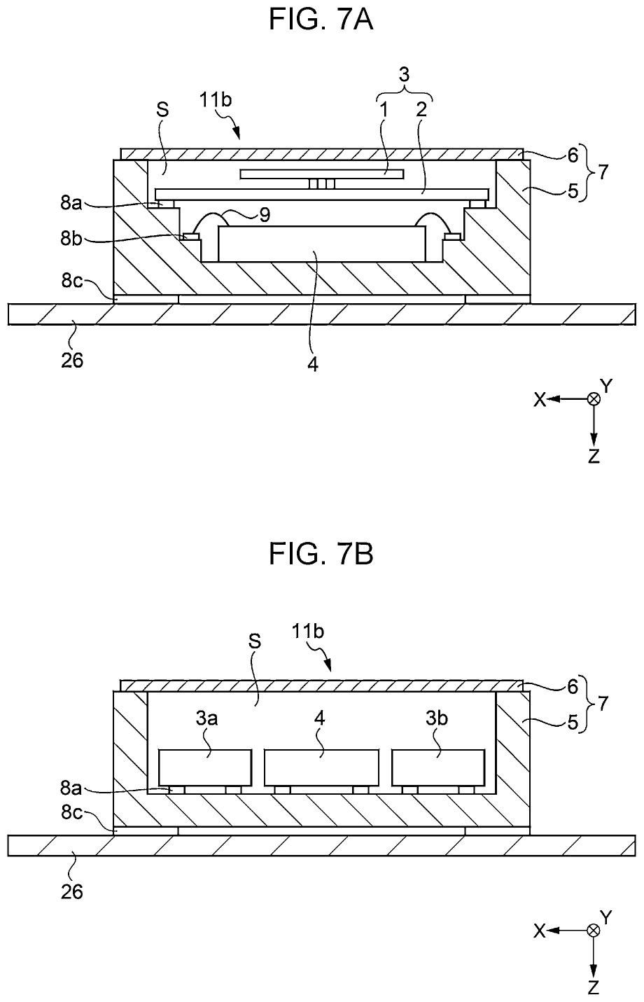

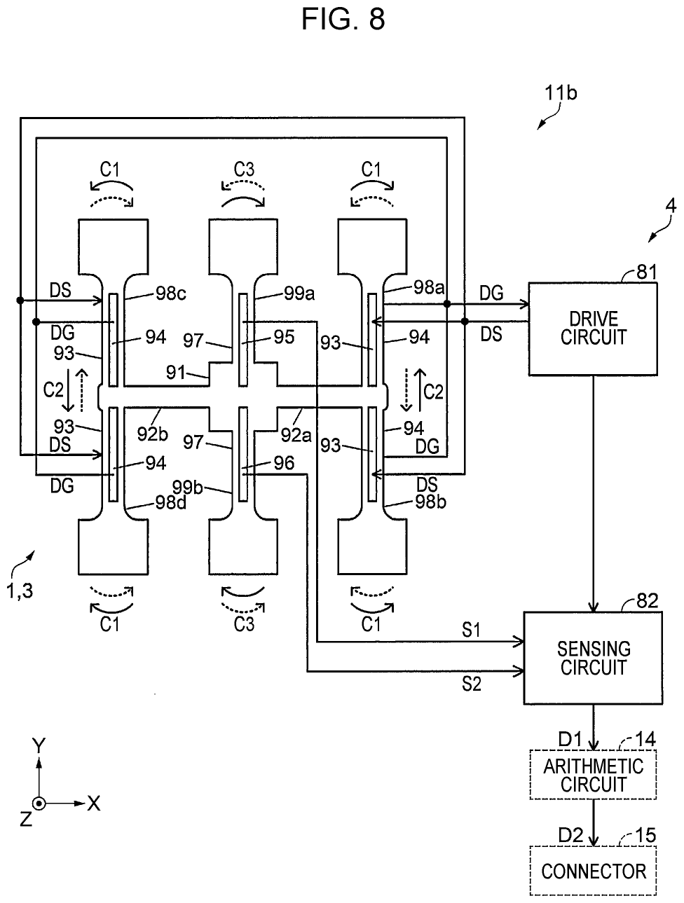

FIGS. 1 to 8 each illustrate a sensor module 100 according to Embodiment 1. FIG. 1 is a perspective view of the sensor module 100 and illustrates a state in which the sensor module 100 is fastened to a mounting surface 71, which is a surface of, for example, an automobile. FIG. 2 is a perspective view of the sensor module 100 in FIG. 1 as seen from the side where the mounting surface 71 is located. FIG. 3 is an exploded perspective view of the sensor module 100. FIG. 4 is a development view of a substrate unit 20. FIG. 5 is a development view of the substrate unit 20. FIG. 6 is a perspective view of a fixation frame 60. FIG. 7A is a sectional view taken along line VIIA-VIIA in FIG. 4 and illustrates an example of a sensor device 11b. FIG. 7B is a sectional view taken along line VIIB-VIIB in FIG. 4 and illustrates another example of the sensor device 11b. FIG. 8 is an explanatory diagram illustrating the internal configuration of the sensor device.

The sensor module 100 according to the present embodiment is an inertial measurement unit (IMU) configured to detect the orientation and behavior of an automobile, a robot, or any other apparatus on which the sensor module 100 is mounted. The apparatus may also be regarded as a moving object. The behavior may also be regarded as inertial momentum.

As illustrated in FIG. 1, the sensor module 100 includes an outer case 50, which is substantially square in shape when viewed in plan. The three-dimensional shape of the outer case 50 is a rectangular parallelepiped. For example, the sensor module 100 has square surfaces each side of which is about 24 mm, and the thickness of the sensor module 100 is about 10 mm.

The outer case 50 houses the substrate unit 20, on which more than one sensor device is mounted. The substrate unit 20 will be described later. The outer case 50 has a lower surface 58, where two threaded holes 52 are provided. The sensor module 100 is to be used in a state in which it is fastened to the mounting surface 71 of the apparatus of interest (e.g., an automobile) with two screws 70 inserted into the respective threaded holes 52.

As illustrated in FIG. 2, an inner case 30 fits in an interior 53 under an upper surface 57 of the outer case 50. The inner case 30 has an upper surface 34, where a cavity 31 is provided. A connector 15, which is a plug-type connector, is disposed in the cavity 31.

The connector 15 includes multiple pins. A socket-type connector (not illustrated) of the apparatus of interest is connected to the connector 15. The sensor module 100 is supplied with power by a power supply circuit of the apparatus through the connector 15 so that the sensor module 100 can transmit electrical signals (e.g., detection data) to the apparatus.

### 1.1. Configuration of Sensor Module

FIG. 3 is an exploded perspective view of the sensor module 100 illustrated in FIG. 2. As illustrated in FIG. 3, the sensor module 100 includes the outer case 50 and a sensor unit 10, which is housed in the outer case 50. The sensor unit 10 includes the inner case 30 and the substrate unit 20 housed in the inner case 30.

The outer case 50 is a machined aluminum base in the form of a box. The material of the outer case 50 is not limited to aluminum. For example, the outer case 50 may be made of zinc, stainless steel, or any other metal or may be made of a composite material containing metal and resin.

The outer case 50 is in the form of a lidless box. The interior 53 of the outer case 50 is an internal space surrounded with a bottom surface 55 and a side wall 54. The sensor unit 10 fits in the internal space of the outer case 50 with a bonding member disposed therebetween.

The sensor unit 10 includes the inner case 30 and the substrate unit 20. The inner case 30 is a member that holds the substrate unit 20 and is shaped to fit in the interior 53 of the outer case 50. When viewed in plan, the inner case 30 has an octagonal shape where four corners at the vertices of a square are chamfered. The upper surface of the inner case 30 has the cavity 31, which is a through-hole. The inner case 30 has a recess 33 therein.

The height of a side wall 32 of the inner case 30 is less than the height of the side wall 54 of the outer case 50. As illustrated in FIG. 2, the upper surface 34 of the inner case 30 is at a level below the upper surface 57 of the outer case 50. A guide pin or a support surface (not illustrated) for positioning the substrate unit 20 is provided in the inner case 30. The substrate unit 20 is positioned with the aid of the guide pin or the support surface and is fastened in place inside the inner case 30 with a bonding member.

### 1.2. Configuration of Substrate Unit

FIG. 4 is a plan view of the substrate unit 20, illustrating a state in which the substrate unit 20 is unfolded and viewed from the minus side in the Z-axis direction. FIG. 5 is a plan view of the substrate unit 20, illustrating a state in which the substrate unit 20 is unfolded and viewed from the plus side in the Z-axis direction. The substrate unit 20 in actual use is assembled as illustrated in FIGS. 3 and 6. When being in the assembled state, the substrate unit 20 in the present embodiment is supported by the fixation frame 60 and is substantially a rectangular parallelepiped.

As illustrated in FIGS. 4 and 5, the substrate unit 20 in the present embodiment includes substrates respectively denoted by 21, 22, 23, 24, 25, and 26, flexible substrates respectively denoted by 41, 42, 43, 44, and 45, sensor devices respectively denoted by 11a, 11b, 12a, 12b, 13a, and 13b, an arithmetic circuit 14, the connector 15, a memory 16, a power supply circuit 17, and a temperature sensor 18.

The substrates 21, 22, 23, 24, 25, and 26 are rigid substrates or, more specifically, glass epoxy substrates. The substrates 21, 22, 23, 24, 25, and 26 may be other kinds of rigid substrates, such as composite substrates or ceramic substrates. The substrates 21, 22, 23, 24, 25, and 26 each may be a multilayer structure or a monolayer structure.

The flexible substrates 41, 42, 43, 44, and 45 are softer than the substrates 21, 22, 23, 24, 25, and 26 and constitute an example of a connection portion 40. The connection portion 40 may be a flexible wiring cable (e.g., a flat cable), a flexible wiring cord (e.g., a flat cord), or a flexible wire. The connection portion 40 may include a connector, solder, a conductive adhesive, or a crimp contact.

The flexible substrate 41 forms an electrical connection between the substrate 21 and the substrate 22. The flexible substrate 42 forms an electrical connection between the substrate 21 and the substrate 23. The flexible substrate 43 forms an electrical connection between the substrate 21 and the substrate 24. The flexible substrate 44 forms an electrical connection between the substrate 21 and the substrate 25. The flexible substrate 45 forms an electrical connection between the substrate 23 and the substrate 26.

The substrates 21, 22, 23, 24, 25, and 26 and the flexible substrates 41, 42, 43, 44, and 45 may be a rigid-flexible substrate including rigid sections and flexible sections. In this case, the rigid sections of the rigid-flexible substrate are the substrates 21, 22, 23, 24, 25, and 26 in the present embodiment, and the flexible sections of the rigid-flexible substrate are the flexible substrates 41, 42, 43, 44, and 45 in the present embodiment.

The sensor devices 11a, 11b, 12a, 12b, 13a, and 13b are angular rate sensors. Specifically, each of the sensor devices is a vibration gyro sensor that includes quartz crystal serving as a vibrator and detects the angular rate on the basis of the Coriolis force applied to the vibrator.

The vibrators included in the respective sensor devices 11a, 11b, 12a, 12b, 13a, and 13b in the present embodiment are configured to be excited at the same driving frequency. It is not required that each of the vibrators be quartz crystal. For example, the vibrators may each be a micro-electro-mechanical systems (MEMS) vibrator including a silicon substrate.

The sensor devices 11a and 11b in the present embodiment are Z-axis angular rate sensors that detect the angular rate about the Z-axis. The sensor devices 12a and 12b in the present embodiment are Y-axis angular rate sensors that detect the angular rate about the Y-axis. The sensor devices 13a and 13b in the present embodiment are X-axis angular rate sensors that detect the angular rate about the X-axis.

The sensor module 100 according to the present embodiment includes two X-axis angular rate sensors, two Y-axis angular rate sensors, and two Z-axis angular rate sensors. The two respective angular rate sensors for each of the X-, Y-, and Z-axes provide angular rate data, and the arithmetic circuit 14 performs calculations based on the angular rate data to obtain, for example, a mean value that is a statistic about the angular rate data provided by the two respective angular rate sensors for each of the X-, Y-, and Z-axes. Accordingly, high-accuracy angular data can be obtained for the respective axes.

As illustrated in FIG. 4, the sensor device 11a is mounted on a lower surface of the substrate 21. The sensor device 12a is mounted on a lower surface of the substrate 22. The sensor device 12b is mounted on a lower surface of the substrate 23. The sensor device 13a is mounted on a lower surface of the substrate 24. The sensor device 13b is mounted on a lower surface of the substrate 25. The sensor device 11b is mounted on a lower surface of the substrate 26.

That is, each of the sensor devices 11a, 11b, 12a, 12b, 13a, and 13b is mounted on the corresponding one of the substrates 21, 22, 23, 24, 25, and 26. Furthermore, each of the flexible substrates 41, 42, 43, 44, and 45 extends between adjacent ones of the substrates to connect them to each other. The flexible substrates 41, 42, 43, 44, and 45 can thus suppress mechanical or electrical interference between the sensor devices 11a, 11b, 12a, 12b, 13a, and 13b operating simultaneously.

As illustrated in FIG. 5, the arithmetic circuit 14, the connector 15, the memory 16, the power supply circuit 17, and the temperature sensor 18 are mounted on an upper surface of the substrate 21. Additional electronic components may be mounted on the upper surface of the substrate 21.

The arithmetic circuit 14 serves as a primary controller for the sensor devices 11a, 11b, 12a, 12b, 13a, and 13b. The arithmetic circuit 14 is an integrated circuit device and may, for example, be configured as a microprocessor unit (MPU) or a central processing unit (CPU).

The arithmetic circuit 14 includes a digital interface. The digital interface is a circuit that executes digital interface processing using communication protocols, such as Serial Peripheral Interface (SPI) or Inter-Integrated Circuit (I2C).

The arithmetic circuit 14 receives detection data output from the sensor devices 11a, 11b, 12a, 12b, 13a, and 13b. The arithmetic circuit 14 then executes various kinds of processing on the detection data and outputs the resultant output data to the outside through the connector 15. The arithmetic circuit 14 in the present embodiment is an example of a processing unit.

Various kinds of processing to be performed by the arithmetic circuit 14 include: processing for obtaining a mean value of the angular rate about the Z-axis on the basis of the data provided by the sensor devices 11a and 11b; processing for obtaining a mean value of the angular rate about the Y-axis on the basis of the data provided by the sensor devices 12a and 12b; processing for obtaining a mean value of the angular rate about the X-axis on the basis of the data provided by the sensor devices 13a and 13b; processing for making corrections to each of the obtained mean values by implementing, for example, temperature correction or zero point correction; processing for sensitivity adjustment; filter processing; and the processing for outputting the resultant data through the connector 15.

The connector 15 is a plug-type connector including two rows of connection terminals arranged with a constant pitch in the X-axis direction. The connector 15 in the present embodiment includes twenty pins arranged in two rows, with ten pins in each row. The number of terminals may be changed as appropriate in accordance with design specifications.

The memory 16 is the location of storage of programs and data, such as programs for various kinds of processing to be executed by the arithmetic circuit 14, programs for incorporating the processed detection data into packet data, and data necessary for execution of the programs (e.g., table data for temperature correction processing).

The power supply circuit 17 is supplied with power by the apparatus of interest and provides necessary power to, for example, the sensor devices 11a, 11b, 12a, 12b, 13a, and 13b and the arithmetic circuit 14.

The temperature sensor 18 outputs temperature information to the arithmetic circuit 14, which executes the temperature correction processing by using the temperature information.

### 1.3. Fixation Frame

FIG. 6 is a perspective view of the fixation frame 60, illustrating a state in which the substrate unit 20 is attached to the fixation frame 60. For convenience of illustration, the substrate 21 is omitted from FIG. 6. The fixation frame 60 is in the shape of an octagonal cylinder when viewed in plan. The fixation frame 60 has cavities 68, each of which is the mounting place for the corresponding one of the substrates 21, 22, 23, 24, 25, and 26. The cavities 68 are relief cavities for the sensor devices 11a, 11b, 12a, 12b, 13a, and 13b.

The substrates 21, 22, 23, 24, 25, and 26 are attached to the fixation frame 60, with the sensor devices 11a, 11b, 12a, 12b, 13a, and 13b facing inward. This means that the sensor devices 11a, 11b, 12a, 12b, 13a, and 13b do not project outward, and the substrate unit 20 is thus compact in size. This leads to miniaturization of the sensor module 100.

The fixation frame 60 is made of, for example, resin. The elastic modulus of the fixation frame 60 is preferably lower than the elastic modulus of each of the substrates 21, 22, 23, 24, 25, and 26 and is preferably higher than the elastic modulus of each of the flexible substrates 41, 42, 43, 44, and 45. The fixation frame 60 having an elastic modulus lower than the elastic modulus of each of the substrates 21, 22, 23, 24, 25, and 26 can suppress mechanical or electrical interference between the sensor devices 11a, 11b, 12a, 12b, 13a, and 13b operating simultaneously. The fixation frame 60 having an elastic modulus higher than the elastic modulus of each of the flexible substrates 41, 42, 43, 44, and 45 enables the substrates 21, 22, 23, 24, 25, and 26 to be kept in desired positions corresponding to the detection axes of the sensor devices mounted on the respective substrates. This eliminates or reduces the possibility that the substrates 21, 22, 23, 24, 25, and 26 will move out of the respective desired positions.

The substrate 21 (not illustrated) is fixed to an upper surface 61 of the fixation frame 60, and the substrate 26 is fixed to a lower surface 62 of the fixation frame 60. That is, the substrates 21 which is the mounting place for the sensor device 11a and 26 which is the mounting place for the sensor device 11b configured to detect the angular rate about the Z-axis, face each other.

The substrate 22 is fixed to a side surface 63 of the fixation frame 60, and the substrate 23 is fixed to a side surface 64 of the fixation frame 60. That is, the substrates 22 which is the mounting place for the sensor device 12a and 23 which is the mounting place for the sensor device 12b configured to detect the angular rate about the Y-axis, face each other.

The substrate 24 is fixed to a side surface 65 of the fixation frame 60, and the substrate 25 is fixed to a side surface 66 of the fixation frame 60. That is, the substrates 24 which is the mounting place for the sensor device 13a and 25 which is the mounting place for the sensor device 13b configured to detect the angular rate about the X-axis, face each other.

The substrate unit 20 in the present embodiment is fixed to the fixation frame 60 during assembly; nevertheless, it is not required that the fixation frame 60 be used for the fixation of the substrate unit 20. For example, the substrate unit 20 may be fixed directly to the inner case 30 without the use of the fixation frame 60.

### 1.4. Sensor Device

### 1.4.1. Packaging

FIGS. 7A and 7B are sectional views for explanation of the packaging of the sensor device 11b. The sensor device 11b in the present embodiment may be a physical quantity sensor configured to detect the angular rate about its detection axis (the Z-axis), as illustrated in FIG. 7A. Alternatively, the sensor device 11b may be a multi-physical quantity sensor configured to detect the angular rate about its detection axis (the Z-axis) and the acceleration along its detection axis (the Z-axis), as illustrated in FIG. 7B.

The sensor device 11b includes a package 7, a sensor element 3, and a circuit element 4 as illustrated in FIG. 7A, or the sensor device 11b includes a package 7, a sensor element 3a, a sensor element 3b, and a circuit element 4 as illustrated in FIG. 7B. The sensor element 3 or the sensor elements 3a and 3b as well as the circuit element 4 are housed in the package 7. The sensor devices 11a, 12a, 12b, 13a, and 13b (not individually illustrated) are structurally identical to the sensor device 11b.

The package 7 includes a base 5 and a lid 6. The base 5 has a recess where the top of the base 5 is open. The lid 6 is bonded to an upper surface of the base 5 with a bonding member disposed therebetween, in which state the opening at the top of the recess is closed with the lid 6. The recess defines an internal space S within the package 7.

The package 7 is, for example, a ceramic package. The base 5 is made of a ceramic material, such as alumina. The lid 6 is made of a ceramic material, such as alumina, or is made of a metallic material, such as Kovar.

The sensor element 3 and the circuit element 4 of the sensor device 11b illustrated in FIG. 7A are disposed in the internal space S. The sensor element 3 is an angular rate sensor that detects the angular rate about the Z-axis. The sensor element 3 includes a vibrator 1 and a support substrate 2. The vibrator 1 is a quartz crystal vibrator. The circuit element 4 includes a detection circuit that will be described later.

The internal space S is airtight. The internal space S is under a reduced pressure and is preferably close to a vacuum. This improves the vibration characteristics of the vibrator 1. However, the atmosphere of the internal space S is not limited to a particular atmosphere.

The vibrator 1, the support substrate 2, and the circuit element 4 overlap each other in the internal space S when viewed in plan. This leads to miniaturization, without an extra increase in the dimension of the package 7 along a plane extending in the X-axis or Y-axis direction.

Internal terminals 8a and internal terminals 8b are disposed in the recess of the base 5, and external terminals 8c are disposed on a lower surface of the base 5. The internal terminals 8a, the internal terminals 8b, and the external terminals 8c are electrically connected to wiring (not illustrated) in the base 5 and on the substrate 26. The internal terminals 8a are electrically connected to the sensor element 3 with a conductive bonding member therebetween, and the internal terminals 8b are electrically connected to the circuit element 4 with bonding wires 9 therebetween.

The sensor element 3a, the sensor element 3b, and the circuit element 4 of the sensor device 11b illustrated in FIG. 7B are disposed in the internal space S. The sensor element 3a is an angular rate sensor that detects the angular rate about the Z-axis. Like the sensor element 3, the sensor element 3a includes a vibrator capable of producing flexural vibration and detects the angular rate on the basis of the Coriolis force.

The sensor element 3b is an acceleration sensor that detects the acceleration along the Z-axis. The sensor element 3b includes a quartz crystal vibrator and detects the acceleration on the basis of changes in the vibration frequency of the quartz crystal vibrator. In some embodiments, the sensor element 3b includes a silicon MEMS and is configured to detect the acceleration on the basis of changes in the capacitance between a fixed electrode and a movable electrode that are comb teeth-shaped electrodes of the MEMS. The circuit element 4 includes a detection circuit that will be described later.

The sensor device 11b is not limited to the one illustrated in FIG. 7B, in which the sensor device 11b includes an angular rate sensor configured to detect the angular rate about the Z-axis and an acceleration sensor configured to detect the acceleration along the Z-axis. For example, the sensor device 11b may include, in addition to the sensor elements 3a and 3b, an angular rate sensor element configured to detect the angular rate about the X-axis and/or an angular rate sensor element configured to detect the angular rate about the Y-axis. Alternatively, the sensor device 11b may include, in addition to the sensor elements 3a and 3b, an acceleration sensor element configured to detect the acceleration along the X-axis and/or an acceleration sensor element configured to detect the acceleration along the Y-axis. The sensor element 3a may, for example, be a three-axis angular rate sensor configured to detect the angular rate about each of the X-, Y-, and Z-axes. The sensor element 3b may, for example, be a three-axis acceleration sensor configured to detect the acceleration along each of the X-, Y-, and Z-axes. The sensor element 3b may, for example, be an angular rate sensor configured to detect the angular rate about the Y-axis or the X-axis or may be a three-axis angular rate sensor configured to detect the angular rate about each of the X-, Y-, and Z-axes. For example, the sensor element 3a may be a three-axis angular rate sensor configured to detect the angular rate about each of the X-, Y-, and Z-axes, and the sensor element 3b may be a three-axis acceleration sensor configured to detect the acceleration along each of the X-, Y-, and Z-axes. In other words, the sensor device 11b may be a three-axis angular sensor, a three-axis acceleration sensor, or a six degrees of freedom (6DoF) sensor.

When being a ceramic package, the package 7 may be regarded as a rigid substrate. In this case, the sensor elements 3, 3a, and 3b may be regarded as the sensor device 11b. When being a ceramic package, the package 7 may be mounted directly on the flexible substrate 45 without the substrate 26 therebetween.

### 1.4.2. Configuration of Sensor Element and Circuit Element

FIG. 8 illustrates detailed example configurations of the sensor element 3 and the circuit element 4 of the sensor device 11b in FIG. 7A. The sensor devices 11a, 12a, 12b, 13a, and 13b are configurationally identical to the sensor device 11b.

The sensor device 11b includes the sensor element 3 and the circuit element 4. The sensor element 3 includes the vibrator 1, and the circuit element 4 includes a drive circuit 81 and a detection circuit 82.

The drive circuit 81 may include: an amplifier circuit that amplifies a feedback signal DG input from the vibrator 1; an automatic gain control (AGC) circuit that performs automatic gain control; and an output circuit that outputs a drive signal DS to the vibrator 1. The AGC circuit variably and automatically adjusts the gain so that the amplitude of the feedback signal DG from the vibrator 1 is maintained constant. The output circuit outputs the drive signal DS to the vibrator 1. For example, the drive signal DS is in the form of a rectangular wave.

The detection circuit 82 may include, for example, an amplifier circuit, a synchronous detection circuit, and an A/D conversion circuit. The amplifier circuit receives detection signals S1 and S2, which are differential signals from the vibrator 1. The amplifier circuit performs charge-to-voltage conversion on the detection signals S1 and S2 and amplifies the detection signals S1 and S2. The synchronous detection circuit performs synchronous detection using a synchronizing signal from the drive circuit 81 to extract a desired wave. After undergoing synchronous detection, the detection signals S1 and S2 in analog form are converted into detection data D1 in digital form by the A/D conversion circuit, which then outputs the detection data D1 to the arithmetic circuit 14.

The arithmetic circuit 14 performs various kinds of processing, such as temperature correction, zero point correction, sensitivity adjustment, filter processing, on the detection data D1. The arithmetic circuit 14 then outputs the resultant data, namely, detection data D2 to the outside through the connector 15.

The vibrator 1 in the present embodiment is a double T-shaped vibrator. Alternatively, the vibrator 1 may, for example, be a tuning fork vibrator or an H-shaped vibrator. The vibrator 1 includes drive arms respectively denoted by 98a, 98b, 98c, and 98d, detection arms respectively denoted by 99a and 99b, a base 91, and linking arms respectively denoted by 92a and 92b.

The base 91 is rectangular in shape. Each of the detection arm 99a, the detection arm 99b, the linking arm 92a, and the linking arm 92b is provided on the corresponding one of the sides of the base 91. The drive arm 98a and the drive arm 98b are provided to the respective tip portions of the linking arm 92a. The drive arm 98c and the drive arm 98d are provided to the respective tip portions of the linking arm 92b.

The drive arms 98a, 98b, 98c, and 98d and the detection arms 99a and 99b have weighting portions for frequency adjustment at their respective tips. Provided that the thickness direction of the vibrator 1 is the Z-axis direction, the vibrator 1 detects the angular rate about the Z-axis.

The drive arms 98a and 98b each have drive electrodes 93 formed on their upper and lower surfaces. The drive arms 98a and 98b each have drive electrodes 94 formed on their right and left side surfaces. The drive arms 98c and 98d each have drive electrodes 94 formed on their upper and lower surfaces. The drive arms 98c and 98d each have drive electrodes 93 formed on their right and left side surfaces.

The drive electrodes 93 and 94 are electrically connected to the drive circuit 81. The drive circuit 81 supplies the drive signal DS to the drive electrodes 93 and receives the feedback signal DG from the drive electrodes 94.

The detection arm 99a has detection electrodes 95 formed on its upper and lower surfaces. The detection arm 99a has ground electrodes 97 formed on its right and left side surfaces. The detection arm 99b has detection electrodes 96 formed on its upper and lower surfaces. The detection arm 99b has ground electrodes 97 formed on its right and left side surfaces. The detection electrodes 95 and the detection electrodes 96 are electrically connected to the detection. The detection signals S1 and S2 from the detection electrodes 95 and 96 are input to the detection.

### 1.4.3. Operation of Sensor Element and Circuit Element

The following describes how the sensor element 3 and the circuit element 4 operate. The drive circuit 81 applies the drive signal DS to the drive electrodes 93 such that the drive arms 98a, 98b, 98c, and 98d produce flexural vibration due to the inverse piezoelectric effect as indicated by arrows C1. Specifically, the tip of the drive arm 98a and the tip of the drive arm 98c alternately move close to and away from each other. Likewise, the tip of the drive arm 98b and the tip of the drive arm 98d alternately move close to and away from each other.

In other words, the drive arms 98a, 98b, 98c, and 98d repeat the vibration pattern indicated by solid arrows C1 and the vibration pattern indicated by dotted arrows C1 at a predetermined frequency. The predetermined frequency is, for example, 49.6 kHz.

In the present embodiment, the frequency at which the drive arms 98a, 98b, 98c, and 98d produce flexural vibration is an example of the driving frequency of the sensor device 11b. Given that there is a correlation between the frequency of the drive signal DS and the frequency at which the drive arms 98a, 98b, 98c, and 98d produce flexural vibration, the driving frequency of the sensor device 11b may be defined by the frequency of the drive signal DS.

The flexural vibration of the drive arms 98a and 98b and the flexural vibration of the drive arms 98c and 98d are mirror images of each other with respect to the X-axis passing through the center of gravity of the base 91. Thus, the base 91, the linking arm 92a, the linking arm 92b, the detection arm 99a, and the detection arm 99b hardly vibrate despite the flexural vibration of the drive arms 98a, 98b, 98c, and 98d.

In this state, the vibrator 1 undergoes the angular displacement about the Z-axis such that a Coriolis force acts on the drive arms 98a, 98b, 98c, and 98d, which in turn vibrate as indicated by arrows C2. In other words, a Coriolis force acts on the drive arms 98a, 98b, 98c, and 98d in the directions of the arrows C2 orthogonal to the arrows C1 and the Z-axis such that vibration components in the directions of the arrows C2 are generated.

The vibration indicated by the arrows C2 is transmitted to the base 91 through the linking arm 92a and the linking arm 92b, and as a result, the detection arm 99a and the detection arm 99b produce flexural vibration in the direction of arrows C3. Charge signals are generated by the piezoelectric effect produced by the flexural vibration of the detection arms 99a and 99b and are input to the detection as the detection signals S1 and S2. In this way, the angular rate about the Z-axis is detected.

As described above, the sensor module 100 according to the present embodiment produces the following effects. The sensor module 100 according to the present embodiment includes the substrate 21, the substrate 26, the connection portion 40, the sensor device 11a, and the sensor device 11b. The substrates 21 and 26 are a first substrate and a second substrate, respectively. The connection portion 40 forms an electrical connection between the substrate 21 and the substrate 26. The sensor device 11a is a first sensor device disposed on the substrate 21 to detect the angular rate about the Z-axis. The angular rate about the Z-axis is a physical quantity on a first axis. The sensor device 11b is a second sensor device disposed on the substrate 26 to detect the angular rate about the Z-axis.

That is, the sensor module 100 according to the present embodiment includes the sensor device 11a and the sensor device 11b that detect the angular rate about the Z-axis. The sensor device 11a and the sensor device 11b are mounted on the substrate 21 and the substrate 26, respectively. The substrates 21 and 26 are electrically connected to each other with the connection portion 40 therebetween.

The sensor module 100 according to the present embodiment precludes the possibility that the sensor device 11a and the sensor device 11b will mechanically and electrically interfere with each other on the same substrate. The sensor module 100 according to the present embodiment can thus yield improvements in the effectiveness and reliability of the enhanced accuracy of the detection data.

The connection portion 40 of the sensor module 100 according to the present embodiment includes the flexible substrate 45. The flexible substrate 45 is a soft substrate. The sensor module 100 according to the present embodiment can thus suppress mechanical or electrical interference between the sensor device 11a and the sensor device 11b operating simultaneously.

According to the present embodiment, the driving frequency of the sensor device 11a of the sensor module 100 is equal to the driving frequency of the sensor device 11b of the sensor module 100. The driving frequency of the sensor devices 11a and 11b is equated with either the frequency of flexural vibration of the drive arms 98a, 98b, 98c, and 98d or the frequency of the drive signal DS.

If the sensor device 11a and the sensor device 11b were mounted on the same substrate, the sensor device 11a and the sensor device 11b would mechanically or electrically interfere with each other. The mechanical or electrical interference between such sensor devices is particularly noticeable when they are driven at the same driving frequency. Thus, the configuration of the sensor module 100 according to the present embodiment is particularly suited for the case in which the driving frequency of the sensor device 11a is equal to the driving frequency of the sensor device 11b. The sensor module 100 according to the present embodiment in which the sensor device 11a and the sensor device 11b are configured to be driven at the same driving frequency eliminates the need to provide sensor devices configured to be driven at different driving frequencies. The present embodiment can effect savings in cost related to, for example, manufacturing, ordering, inventory, or assembly of the sensor devices 11a and 11b configured to be driven at different driving frequencies and thus provides the sensor module 100 with added value for industrial use.

The sensor module 100 according to the present embodiment includes the arithmetic circuit 14 that is a processing unit. The arithmetic circuit 14 is disposed on the substrate 21 to process the detection data D1 provided as a first detection signal from the sensor device 11a and the detection data D1 provided as a second detection signal from the sensor device 11b.

The detection data D1 from the sensor device 11a and the detection data D1 from the sensor device 11b are each processed by the arithmetic circuit 14 disposed on the substrate 21. The resultant data obtained is the detection data D2. The sensor module 100 according to the present embodiment eliminates or reduces the possibility that the sensor device 11a and the sensor device 11b will interfere with each other. Thus, the effectiveness of the enhanced accuracy is ensured, and the detection data D2 with high accuracy and reliability is obtained accordingly.

The sensor module 100 according to the present embodiment includes the connector 15. The connector 15 is disposed on the substrate 21 and is electrically connected to the arithmetic circuit 14. Given that the effectiveness of the enhanced accuracy is ensured, the sensor module 100 according to the present embodiment can output the detection data D2 with high accuracy and reliability to the outside through the connector 15.

The sensor module 100 according to the present embodiment includes the substrate 23 and the sensor device 12b. The substrate 23 is a third substrate. The sensor device 12b is a third sensor device disposed on the substrate 23 to determine the angular rate about the Y-axis. The angular rate about the Y-axis is a physical quantity on a second axis. The substrate 21, the substrate 26, and the substrate 23 are glass epoxy substrates that are rigid substrates. The connection portion 40 includes the flexible substrate 42 and the flexible substrate 45 that are a first flexible substrate and a second flexible substrate, respectively. One end and the other end of the flexible substrate 42 are coupled to the substrate 21 and the substrate 23, respectively. One end and the other end of the flexible substrate 45 are coupled to the substrate 23 and the substrate 26, respectively.

That is, the sensor module 100 according to the present embodiment includes the sensor device 11a, the sensor device 11b, and the sensor device 12b. The sensor device 11a and the sensor device 11b detect the angular rate about the Z-axis. The sensor device 12b detects the angular rate about the Y-axis. The sensor device 11a, the sensor device 11b, and the sensor device 12b are mounted on the substrate 21, the substrate 26, and the substrate 23, respectively. The substrate 21 and the substrate 23 are electrically connected to each other with the flexible substrate 42 therebetween. The substrate 23 and the substrate 26 are electrically connected to each other with the flexible substrate 45 therebetween.

The sensor module 100 according to the present embodiment precludes the possibility that the sensor device 11a, the sensor device 11b, and the sensor device 12b will mechanically and electrically interfere with each other on the same substrate. The sensor module 100 according to the present embodiment can thus yield improvements in the effectiveness and reliability of the enhanced accuracy of the detection data.

The substrate 21 and the substrate 26 of the sensor module 100 according to the present embodiment face each other. Each of the substrates 21 and 26 is the mounting place for the corresponding one of the sensor devices configured to detect the angular rate about the Z-axis. With a high degree of effectiveness afforded by the substrates 21 and 26 facing each other, the sensor module 100 according to the present embodiment can carry out a highly accurate measurement of the angular rate about the Z-axis. The sensor module 100 according to the present embodiment can thus yield improvements in the effectiveness of the enhanced accuracy of the angular rate about the Z-axis.

The sensor module 100 according to the present embodiment includes the fixation frame 60. The fixation frame 60 is a fixation portion to which the substrate 21 and the substrate 26 are fixed. The substrate 21 and the substrate 26 are fixed to the fixation frame 60. In this way, the present embodiment enables easy and reliable fixation of the substrate 21 and the substrate 26 of the sensor module 100. The sensor module 100 according to the present embodiment can thus yield improvements in the effectiveness and reliability of the enhanced accuracy of the detection data.

The sensor module 100 according to the present embodiment includes the inner case 30 and/or the outer case 50. Each of the inner case 30 and the outer case 50 is a case in which the substrate 21, the substrate 26, and the connection portion 40 can be housed. The inner case 30 and/or the outer case 50 used as a housing can reject external influence. The sensor module 100 according to the present embodiment can thus yield improvements in the effectiveness and reliability of the enhanced accuracy of the detection data.

### 2. Embodiment 2

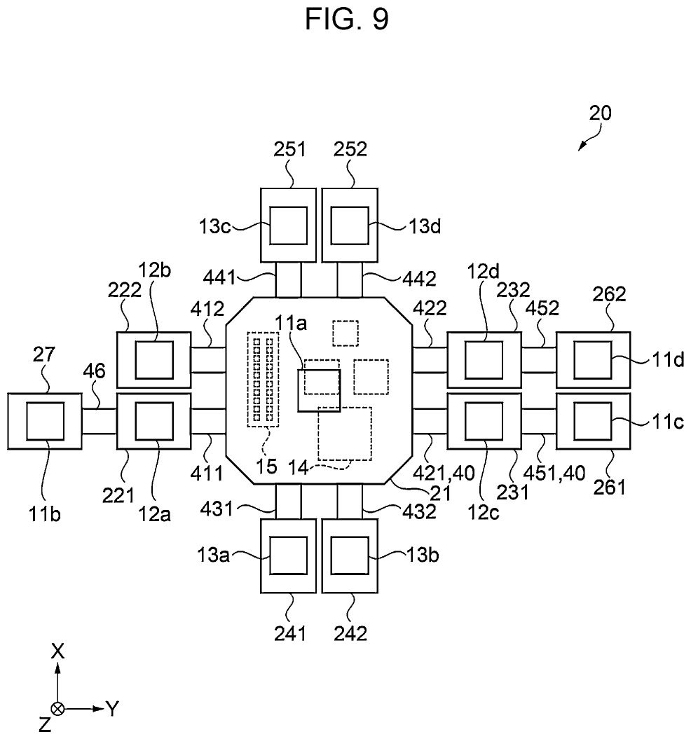

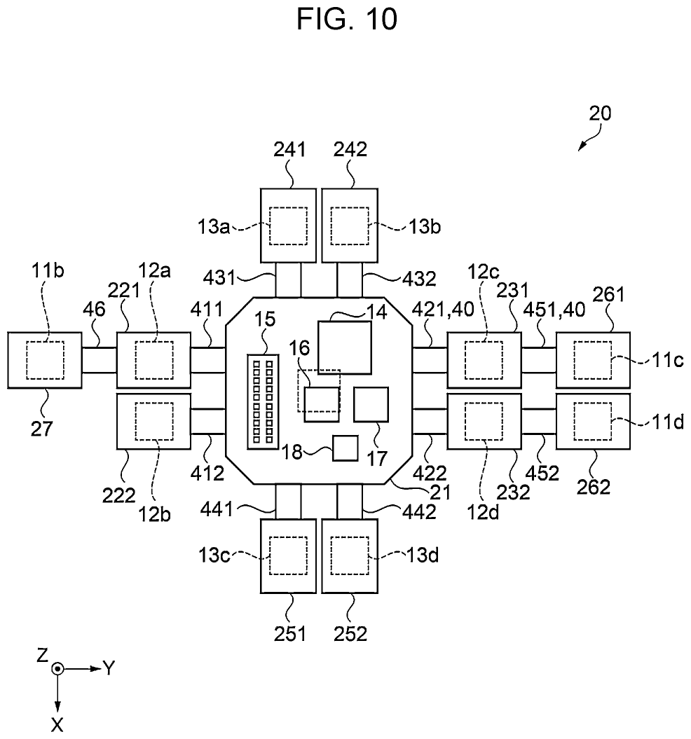

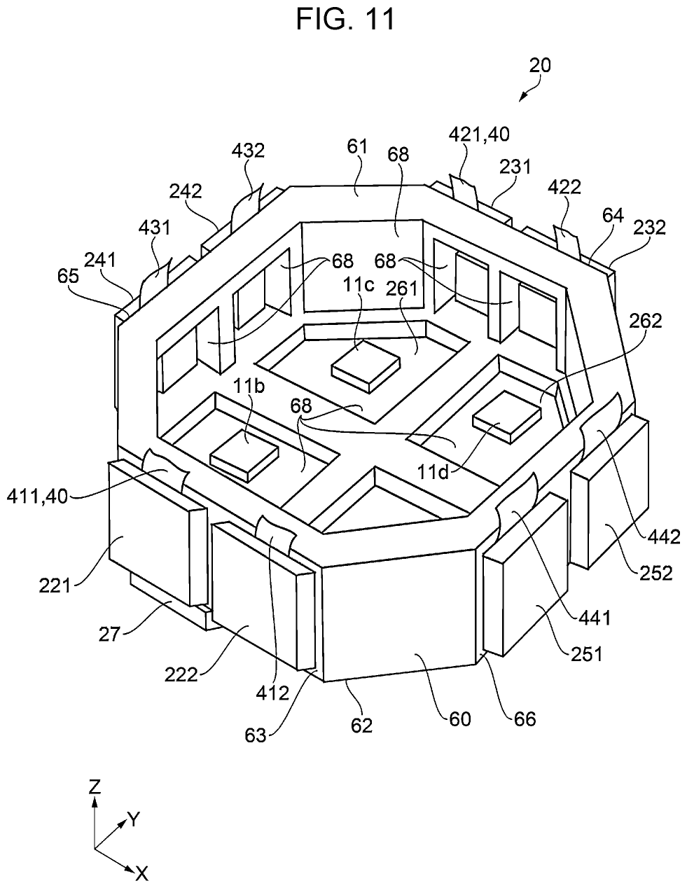

FIGS. 9 to 11 illustrate a sensor module 100 according to Embodiment 2. FIG. 9 is a development view of a substrate unit 20 and is a plan view of the substrate unit 20, illustrating a state in which the substrate unit 20 is unfolded and viewed from the minus side in the Z-axis direction. FIG. 10 is a development view of a substrate unit 20 and is a plan view of the substrate unit 20, illustrating a state in which the substrate unit 20 is unfolded and viewed from the plus side in the Z-axis direction. FIG. 11 is a perspective view of a fixation frame 60, illustrating a state in which the substrate unit 20 is attached to the fixation frame 60. For convenience of illustration, the substrate 21 is omitted from FIG. 11. Some components in Embodiment 2 may be identical to those described in Embodiment 1. Each of these components in Embodiment 2 and the corresponding component in Embodiment 1 may be denoted by the same reference sign, and not every one of them will be further elaborated on here.

### 2.1. Configuration of Substrate Unit

The substrate unit 20 in Embodiment 2 includes substrates respectively denoted by 21, 221, 222, 231, 232, 241, 242, 251, 252, 261, 262, and 27, flexible substrates respectively denoted by 411, 412, 421, 422, 431, 432, 441, 442, 451, 452, and 46, sensor devices respectively denoted by 11a, 11b, 11c, 11d, 12a, 12b, 12c, 12d, 13a, 13b, 13c, and 13d, an arithmetic circuit 14, a connector 15, a memory 16, a power supply circuit 17, and a temperature sensor 18.

The substrates 21, 221, 222, 231, 232, 241, 242, 251, 252, 261, 262, and 27 are rigid substrates, such as glass epoxy substrates, composite substrates, or ceramic substrates.

The flexible substrates 411, 412, 421, 422, 431, 432, 441, 442, 451, 452, and 46 constitute an example of a connection portion 40. The flexible substrate 411 forms an electrical connection between the substrate 21 and the substrate 221. The flexible substrate 412 forms an electrical connection between the substrate 21 and the substrate 222. The flexible substrate 421 forms an electrical connection between the substrate 21 and the substrate 231. The flexible substrate 422 forms an electrical connection between the substrate 21 and the substrate 232. The flexible substrate 431 forms an electrical connection between the substrate 21 and the substrate 241. The flexible substrate 432 forms an electrical connection between the substrate 21 and the substrate 242. The flexible substrate 441 forms an electrical connection between the substrate 21 and the substrate 251. The flexible substrate 442 forms an electrical connection between the substrate 21 and the substrate 252. The flexible substrate 451 forms an electrical connection between the substrate 231 and the substrate 261. The flexible substrate 452 forms an electrical connection between the substrate 232 and the substrate 262. The flexible substrate 46 forms an electrical connection between the substrate 221 and the substrate 27.

The substrates 21, 221, 222, 231, 232, 241, 242, 251, 252, 261, 262, and 27 and the flexible substrates 411, 412, 421, 422, 431, 432, 441, 442, 451, 452, and 46 may be a rigid-flexible substrate.

The sensor devices 11a, 11b, 11c, 11d, 12a, 12b, 12c, 12d, 13a, 13b, 13c, and 13d are angular rate sensors. Specifically, each of the sensor devices is a vibration gyro sensor that includes quartz crystal serving as a vibrator.

The vibrators included in the respective sensor devices 11a, 11b, 11c, 11d, 12a, 12b, 12c, 12d, 13a, 13b, 13c, and 13d in Embodiment 2 are configured to be excited at the same driving frequency. It is not required that each of the vibrators be quartz crystal. For example, the vibrators each may be a MEMS vibrator including a silicon substrate.

The sensor devices 11a, 11b, 11c, and 11d in Embodiment 2 are Z-axis angular rate sensors that detect the angular rate about the Z-axis. The sensor devices 12a, 12b, 12c, and 12d in Embodiment 2 are Y-axis angular rate sensors that detect the angular rate about the Y-axis. The sensor devices 13a, 13b, 13c, and 13d in Embodiment 2 are X-axis angular rate sensors that detect the angular rate about the X-axis.

The sensor module 100 in Embodiment 2 includes four X-axis angular rate sensors, four Y-axis angular rate sensors, and four Z-axis angular rate sensors. The four respective angular rate sensors for each of the X-, Y-, and Z-axes provide angular rate data, and the arithmetic circuit 14 performs calculations based on the angular rate data to obtain, for example, a mean value that is a statistic about the angular rate data provided by the four respective angular rate sensors for each of the X-, Y-, and Z-axes. Accordingly, high-accuracy angular data can be obtained for the respective axes.

As illustrated in FIG. 9, the sensor device 11a is mounted on a lower surface of the substrate 21. The sensor device 12a is mounted on a lower surface of the substrate 221. The sensor device 12b is mounted on a lower surface of the substrate 222. The sensor device 12c is mounted on a lower surface of the substrate 231. The sensor device 12d is mounted on a lower surface of the substrate 232. The sensor device 13a is mounted on a lower surface of the substrate 241. The sensor device 13b is mounted on a lower surface of the substrate 242. The sensor device 13c is mounted on a lower surface of the substrate 251. The sensor device 13d is mounted on a lower surface of the substrate 252. The sensor device 11c is mounted on a lower surface of the substrate 261. The sensor device 11d is mounted on a lower surface of the substrate 262. The sensor device 11b is mounted on a lower surface of the substrate 27.

As illustrated in FIG. 10, the arithmetic circuit 14, the connector 15, the memory 16, the power supply circuit 17, and the temperature sensor 18 are mounted on an upper surface of the substrate 21. The arithmetic circuit 14 serves as a primary controller for the sensor devices 11a, 11b, 11c, 11d, 12a, 12b, 12c, 12d, 13a, 13b, 13c, and 13d.

The arithmetic circuit 14 receives detection data output from the sensor devices 11a, 11b, 11c, 11d, 12a, 12b, 12c, 12d, 13a, 13b, 13c, and 13d. The arithmetic circuit 14 then executes various kinds of processing and outputs the resultant output data to the outside through the connector 15.

Various kinds of processing to be performed by the arithmetic circuit 14 include: processing for obtaining a mean value of the angular rate about the Z-axis on the basis of the data provided by the sensor devices 11a, 11b, 11c, and 11d; processing for obtaining a mean value of the angular rate about the Y-axis on the basis of the data provided by the sensor devices 12a, 12b, 12c, and 12d; processing for obtaining a mean value of the angular rate about the X-axis on the basis of the data provided by the sensor devices 13a, 13b, 13c, and 13d; processing for making corrections to each of the obtained mean values by implementing, for example, temperature correction or zero point correction; processing for sensitivity adjustment; filter processing; and the processing for outputting the resultant data through the connector 15.

### 2.2. Fixation Frame

FIG. 11 is a perspective view of a fixation frame 60, illustrating a state in which the substrate unit 20 is attached to the fixation frame 60. For convenience of illustration, the substrate 21 is omitted from FIG. 11. The substrate unit 20 in the assembled state is supported by the fixation frame 60 and is substantially a rectangular parallelepiped. The fixation frame 60 is in the shape of an octagonal cylinder when viewed in plan. The fixation frame 60 has cavities 68, each of which is the mounting place for the corresponding one of the substrates 21, 221, 222, 231, 232, 241, 242, 251, 252, 261, 262, and 27.

The substrates 21, 221, 222, 231, 232, 241, 242, 251, 252, 261, 262, and 27 are attached to the fixation frame 60, with the sensor devices 11a, 11b, 11c, 11d, 12a, 12b, 12c, 12d, 13a, 13b, 13c, and 13d facing inward.

The substrate 21 (not illustrated) is fixed to an upper surface 61 of the fixation frame 60, and the substrates 261, 262, and 27 are fixed to a lower surface 62 of the fixation frame 60. That is, each of the substrates 21, 261, 262, and 27 is the mounting place for the corresponding one of the sensor devices that detect the angular rate about the Z-axis, and the substrates 21 faces the substrates 261, 262, and 27.

The substrates 221 and 222 are fixed to a side surface 63 of the fixation frame 60, and the substrates 231 and 232 are fixed to a side surface 64 of the fixation frame 60. That is, each of the substrates 221, 222, 231, and 232 is the mounting place for the corresponding one of the sensor devices that detect the angular rate about the Y-axis, and the substrates 221, 222, 231, and 232 are disposed on the side surfaces 63 and 64 that face each other. The substrates 241 and 242 are fixed to a side surface 65 of the fixation frame 60, and the substrates 251 and 252 are fixed to a side surface 66 of the fixation frame 60. That is, each of the substrates 241, 242, 251, and 252 is the mounting place for the corresponding one of the sensor devices that detect the angular rate about the X-axis, and the substrates 241, 242, 251, and 252 are disposed on the side surfaces 65 and 66 that face each other.

As described above, two sensor devices or four sensor devices are provided for each of the X-, Y-, and Z-axes. In some embodiments, however, three sensor devices or five or more sensor devices are provided for each of the X-, Y-, and Z-axes. As described above, the same number of sensor devices are provided for each of the X-, Y-, and Z-axes. In some embodiments, however, the number of sensor devices differs from axis to axis. For example, two sensor devices for the X-axis, two sensor devices for the Y-axis, and four sensor devices for the Z-axis may be provided. As described above, more than one sensor device is provided for each of the X-, Y-, and Z-axes. In some embodiments, however, more than one sensor device is provided for a specific axis. For example, one sensor device for the X-axis, one sensor device for the Y-axis, and two sensor devices for the Z-axis may be provided.

As described above, the sensor module 100 according to Embodiment 2 produces the following effects as well as the effects mentioned above in relation to Embodiment 1.

The sensor module 100 according to Embodiment 2 includes the substrate 21, the substrate 261, the connection portion 40, the sensor device 11a, and the sensor device 11b. The substrates 21 and 261 are a first substrate and a second substrate, respectively. The connection portion 40 forms an electrical connection between the substrate 21 and the substrate 261. The sensor device 11a is a first sensor device disposed on the substrate 21 to detect the angular rate about the Z-axis. The angular rate about the Z-axis is a physical quantity on a first axis. The sensor device 11c is a second sensor device disposed on the substrate 261 to detect the angular rate about the Z-axis.

That is, the sensor module 100 according to the present embodiment includes the sensor device 11a and the sensor device 11c that detect the angular rate about the Z-axis. The sensor device 11a and the sensor device 11c are mounted on the substrate 21 and the substrate 261, respectively. The substrates 21 and 261 are electrically connected to each other with the connection portion 40 therebetween. The sensor module 100 according to Embodiment 2 precludes the possibility that the sensor device 11a and the sensor device 11c will mechanically and electrically interfere with each other on the same substrate. The sensor module 100 according to Embodiment 2 can thus yield improvements in the effectiveness and reliability of the enhanced accuracy of the detection data.

### 3. Embodiment 3

Embodiment 3 describes an electronic apparatus including the sensor module 100. A portable device (e.g., a smartphone) and a mobile object (e.g., an automobile) are described below as examples of the electronic apparatus.

### 3.1. Overview of Portable Device

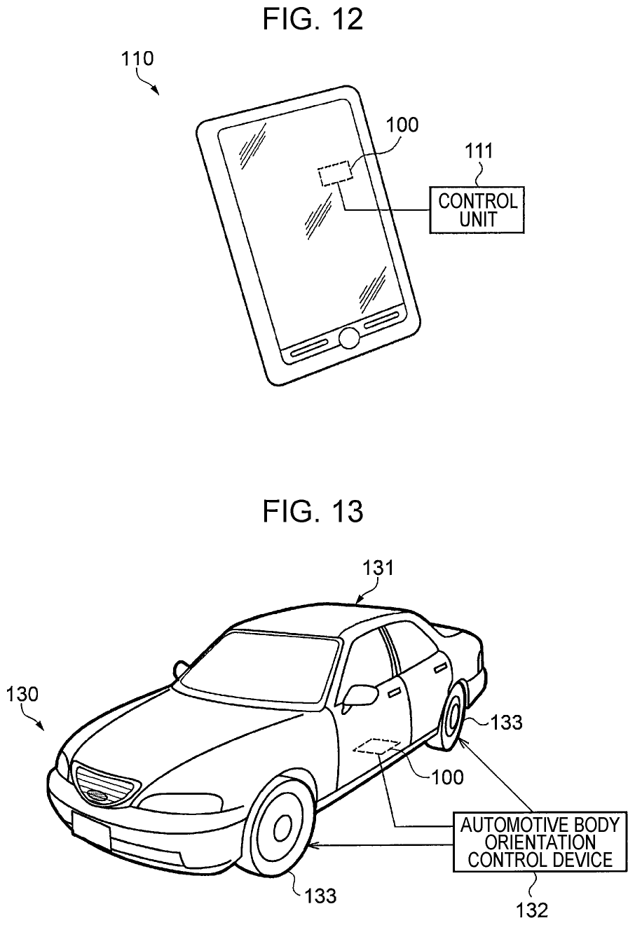

FIG. 12 is a perspective view of a portable device described below as the electronic apparatus according to Embodiment 3. The configuration of a smartphone 110, which is an example of the portable device, is illustrated in FIG. 12.

The smartphone 110 has the sensor module 100 built therein. The data output from the sensor module 100 is received by a control unit 111. Upon receipt of detection signals, the control unit 111 recognizes the orientation and behavior of the smartphone 110 on the basis of the detection signals. The control unit 111 then changes an image displayed on a display unit, produces alarm sounds or sound effects, or drives a vibration motor of the smartphone 110 to cause a main body of the smartphone 110 to vibrate.

The sensor module 100 may be built in a portable device other than the smartphone 110. For example, the sensor module 100 may be built in a portable device such as a smartwatch, a portable activity meter, a head-mounted display (HMD), a mobile personal computer (PC), a tablet PC, a camera, or a personal digital assistant (PDA). The output data from the sensor module 100 is used to determine the orientation and behavior of the portable device, in which case the portable device changes its screen image, produces alarm sounds or sound effects, or drives a vibration motor to cause its main body to vibrate.

As described above, the portable device (e.g., the smartphone 110) in the present embodiment has the sensor module 100 built therein. Thus, the advantage of the present embodiment is the improved reliability of the portable device including the sensor module 100.

### 3.2. Overview of Mobile Object

FIG. 13 is a perspective view of a mobile object described below as the electronic apparatus according to Embodiment 3. The configuration of an automobile 130, which is an example of the mobile object, is illustrated in FIG. 13.

The automobile 130 has the sensor module 100 built therein. The sensor module 100 determines the orientation of an automotive body 131 and then transmits output data to an automotive body orientation control device 132. The output data includes an angular rate signal and an acceleration signal. The automotive body orientation control device 132, which is configured to control the orientation of the automotive body 131, receives the output data from the sensor module 100 and then determines the orientation of the automotive body 131 on the basis of the signals. The automotive body orientation control device 132 controls, in accordance with the determination result, the suspension stiffness or the brakes on wheels 133.

The output data from the sensor module 100 may also find application in keyless entry, immobilizers, car navigation systems, automobile air conditioners, anti-lock braking systems (ABS), air bags, tire pressure monitoring systems (TPMS), engine control, inertial navigation control equipment for automated driving, and electronic control units (ECUs) such as battery monitors for hybrid vehicles and electric vehicles.

The sensor module 100 may be built in a mobile object other than the automobile 130. Examples of such a mobile object include biped robots, trains, radio-controlled airplanes, radio-controlled helicopters, drones, agricultural machinery, and construction machinery. The mobile object having the sensor module 100 built therein can exploit the output data from the sensor module 100 in, for example, the control of the orientation of the mobile object and measurements of the position of the mobile object.

As described above, the mobile object (e.g., the automobile 130) in the present embodiment has the sensor module 100 built therein. Thus, the advantage of the present embodiment is the improved reliability of the mobile object including the sensor module 100.

The present disclosure has been described on the basis of preferred embodiments but is not limited to the embodiments. Each constituent component described herein may be replaced with any element capable of performing the same functions mentioned above in relation to the embodiments and may be supplemented with any such element.

What is claimed is:

1. A sensor module comprising:
a first substrate;
a second substrate;
a connection portion forming an electrical connection between the first substrate and the second substrate;
a first sensor device disposed on the first substrate to detect a physical quantity on a first axis; and
a second sensor device disposed on the second substrate to detect a physical quantity on the first axis.

2. The sensor module according to claim 1, wherein the connection portion includes a flexible substrate.

3. The sensor module according to claim 1, wherein a driving frequency of the first sensor device is equal to a driving frequency of the second sensor device.

4. The sensor module according to claim 1, further comprising a processing unit disposed on the first substrate to process a first detection signal from the first sensor device and a second detection signal from the second sensor device.

5. The sensor module according to claim 4, further comprising a connector that is disposed on the first substrate and that is electrically connected to the processing unit.

6. The sensor module according to claim 1, further comprising:
a third substrate; and
a third sensor device disposed on the third substrate to detect a physical quantity on a second axis, wherein
the first substrate, the second substrate, and the third substrate are rigid substrates, and
the connection portion includes
a first flexible substrate with one end coupled to the first substrate and the other end coupled to the third substrate, and
a second flexible substrate with one end coupled to the third substrate and the other end coupled to the second substrate.

7. The sensor module according to claim 1, wherein the first substrate and the second substrate face each other.

8. The sensor module according to claim 1, further comprising a fixation portion to which the first substrate and the second substrate are fixed.

9. The sensor module according to claim 1, further comprising a case in which the first substrate, the second substrate, and the connection portion are housed.

10. A sensor module comprising:
a first substrate;
a second substrate disposed close to one side of the first substrate;
a third substrate disposed close to the one side of the first substrate;
a first connection portion forming an electrical connection between the first substrate and the second substrate;
a second connection portion forming an electrical connection between the first substrate and the third substrate;
a first sensor device disposed on the second substrate to detect a physical quantity on a first axis; and
a second sensor device disposed on the third substrate to detect a physical quantity on the first axis.

11. The sensor module according to claim 10, wherein
the first connection portion is a first flexible substrate with one end coupled to the second substrate and the other end coupled to the one side of the first substrate, and
the second connection portion is a second flexible substrate with one end coupled to the third substrate and the other end coupled to the one side of the first substrate.

12. The sensor module according to claim 10, further comprising:
a fourth substrate facing the first substrate;
a fifth substrate facing the first substrate;
a third connection portion forming an electrical connection between the fourth substrate and the second substrate;
a fourth connection portion forming an electrical connection between the fifth substrate and the third substrate;
a third sensor device disposed on the fourth substrate to detect a physical quantity on a second axis; and
a fourth sensor device disposed on the fifth substrate to detect a physical quantity on the second axis.

13. The sensor module according to claim 12, wherein
the first connection portion is a first flexible substrate with one end coupled to the second substrate and the other end coupled to the one side of the first substrate,
the second connection portion is a second flexible substrate with one end coupled to the third substrate and the other end coupled to the one side of the first substrate,
the third connection portion is a third flexible substrate with one end coupled to the second substrate and the other end coupled to the fourth substrate, and
the fourth connection portion is a fourth flexible substrate with one end coupled to the third substrate and the other end coupled to the fifth substrate.

14. The sensor module according to claim 10, wherein a driving frequency of the first sensor device is equal to a driving frequency of the second sensor device.

15. The sensor module according to claim 10, further comprising a processing unit disposed on the first substrate to process a first detection signal from the first sensor device and a second detection signal from the second sensor device.

16. The sensor module according to claim 15, further comprising a connector that is disposed on the first substrate and that is electrically connected to the processing unit.

17. The sensor module according to claim 10, further comprising a fixation portion to which the first substrate, the second substrate, and the third substrate are fixed.

18. The sensor module according to claim 10, further comprising a case in which the first substrate, the second substrate, the third substrate, the first connection portion, and the second connection portion are housed.

19. An electronic apparatus comprising the sensor module according to claim 1.
